(19) United States
(12) Patent Application Publication
(10) Pub. No.: US 2014/0372778 A1
(43) Pub. Date: Dec. 18, 2014

(54) SERVER BACKPLANE

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: BO TIAN, Shenzhen (CN); YU HAN, Shenzhen (CN)

(21) Appl. No.: 14/302,560

(22) Filed: Jun. 12, 2014

(30) Foreign Application Priority Data
Jun. 13, 2013 (CN) 2013102315444

(51) Int. Cl. G06F 13/40; G06F 1/32

(52) U.S. Cl. CPC G06F 13/4081; G06F 1/324
USPC 713/322; 710/302

(57) ABSTRACT

A server backplane includes a circuit board, a first connector, a second connector, a power connector, a plurality of hard disk drive interfaces to be coupled to HDDs, a HDD controller interface, and a controller coupled to the plurality of HDD interfaces and the HDD controller interface. The controller can detect the respective statuses of all the HDD according to report signals from the HDD controller interface and status signals from the HDD interfaces.

### CROSS-REFERENCE TO RELATED APPLICATIONS

This application claims priority to Chinese Patent Application No. 201310231544.4 filed on Jun. 13, 2013 in the China Intellectual Property Office, the contents of which are incorporated by reference herein.

### FIELD

The subject matter herein generally relates to server backplanes.

### BACKGROUND

Backplanes are important components in a server. A number of backplanes are adapted to connect to a number of hard disk drives (HDDs) to enlarge the capacity of the server. The backplane may include various types, such as a two-interface type and a four-interface type, to be connected with different numbers of HDDs.

### BRIEF DESCRIPTION OF THE DRAWINGS

Implementations of the present technology will now be described, by way of example only, with reference to the attached figures, wherein:

FIG. 1 is a block diagram of a server backplane of the present disclosure, wherein the server backplane can comprise first, second, third, and fourth connectors, a converting circuit, and a frequency generating circuit.

FIG. 2 is a circuit diagram of the first, second, third, and fourth connectors of FIG. 1.

FIG. 3 is a circuit diagram of the converting circuit of FIG. 1.

FIG. 4 is a circuit diagram of the frequency generating circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to backplanes that can be combined with each other to form larger backplanes and for adaptation to different types of server.

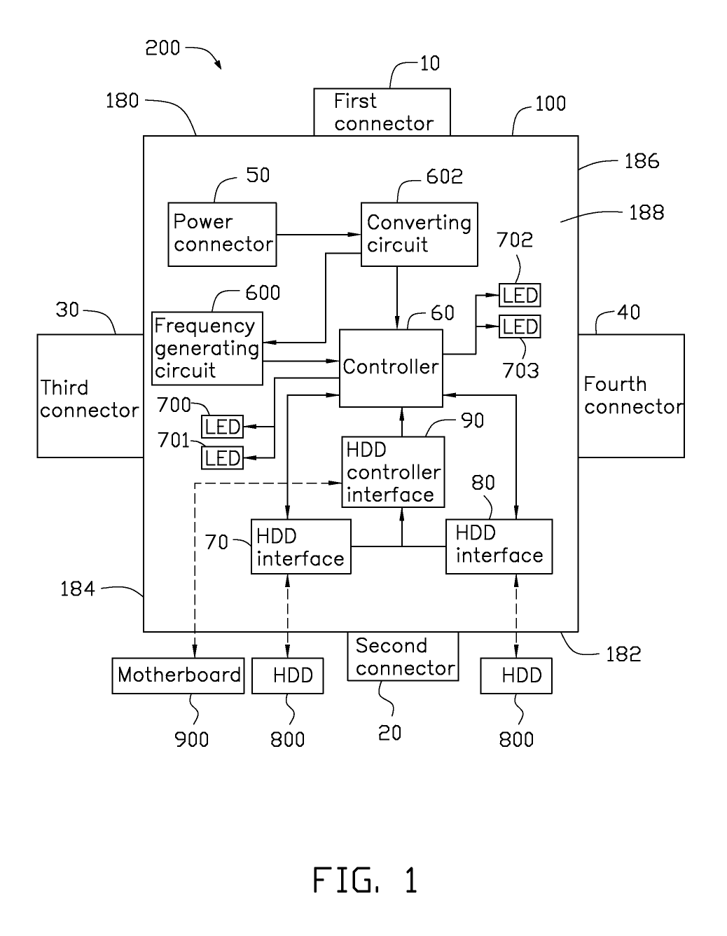

FIG. 1 illustrates is a block diagram of a server backplane of the present disclosure. A server backplane 200 can comprise a circuit board 100, a first connector 10 arranged at a first side 180 of the circuit board 100, a second connector 20 arranged at a second side 182 of the circuit board 100, a power connector 50 arranged at a surface 188 of the circuit board 100, a plurality of hard disk drive (HDD) interfaces 70 to be coupled to multiple HDDs 800, a HDD controller interface 90 coupled to a plurality of HDD interfaces 70, a frequency generating circuit 600, a converting circuit 602, and a controller 60 coupled to the plurality of HDD interfaces 70 and to the HDD controller interface 90. The power connector 50 can be coupled to the first connector 10 and the second connector 20. The plurality of HDD interfaces 90 can be coupled to a motherboard 900, to communicate with the motherboard 900.

The circuit board 100 can be substantially rectangular. The first side 180 is opposite to the second side 182 of the circuit board 100. The circuit board 100 can further comprise a third side 184 and a fourth side 186 opposite to the third side 184. The server backplane 200 can further comprise a third connector 30 arranged at the third side 184, and a fourth connector 40 arranged at the fourth side 186.

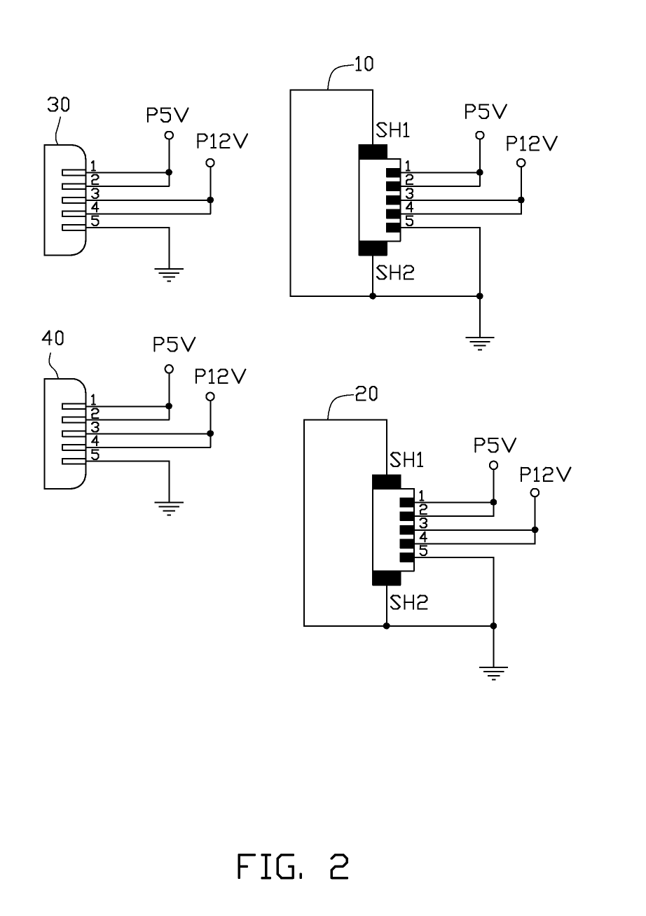

FIG. 2 illustrates a circuit diagram of the first, second, third, and fourth connectors, 10, 20, 30, and 40. Each connector can comprise five pins 1-5. The pins 1 and 2 of each connector can be coupled to a power terminal P5V. The pins 3 and 4 of each connector can be coupled to a power terminal P12V. The pin 5 of each connector can be connected to ground. In the embodiment, pins SH1 and SH2 of the first and second connectors 10 and 20 can be connected to ground.

In one embodiment, the first and second connectors 10 and 20 are male connectors, and the third and fourth connectors 30 and 40 are female connectors.

In one embodiment, the HDD interfaces 70 and 80 can output signals as to the respective status of the HDDs 800, to the controller 60. The HDD interfaces 70 and 80 can be serial advanced technology attachment (SATA) interfaces.

The HDD controller interface 90 can generate report signals to the controller 60 according to the communication between the HDD 800 and the motherboard 900. In one embodiment, the HDD controller interface 90 is a mini-serial attached small computer system (Mini SAS) interface.

In one embodiment, the server backplane 200 can further comprise a plurality of light-emitting lights (LEDs). The controller 60 can detect respective statuses of the HDDs 800 according to the report signal from the HDD controller interface 90 and status signals from the HDD interfaces 70, and drive the LEDs to make the LEDs emit light. Accordingly, the LEDs can indicate the statuses of the HDDs 800. In one embodiment, the controller 60 can be a complex programmable logic controller (CPLD) chip. For example, the server backplane 200 can comprise first, second, third, and fourth LEDs, 700-703. The first and second LEDs 700 and 701 can be configured to indicate the status of the HDD 800 coupled to the HDD interface 70. The controller 60 can detect the status of the HDD 800 coupled to the HDD interface 70 according to the report and the status signal. If the HDD 800 coupled to the HDD interface 70 is working normally, the controller 60 can output a first drive signal to control the LED 700 to emit light. If the HDD 800 coupled to the HDD interface 70 is malfunctioning, the controller 60 can output a second drive signal to control the LED 701 to emit light. The LEDs 702 and 703 can indicate every possible status of the HDD 800 which is coupled to the HDD interface 80.

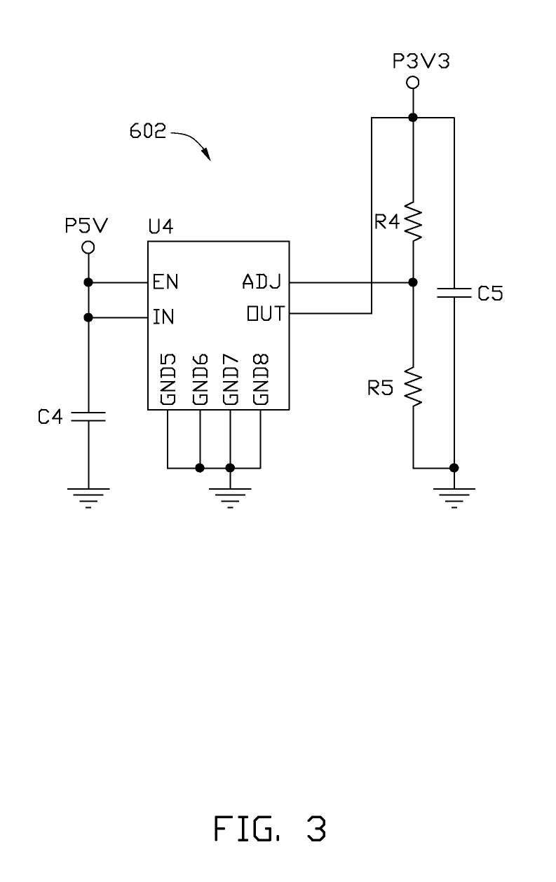

FIG. 3 illustrates a circuit diagram of the converting circuit 602. The converting circuit 602 can be coupled to the power connector 50. The converting circuit 602 can regulate the voltage output from the power connector 50. The converting circuit 602 can comprise a converting chip U4. An input pin IN of the converting chip U4 can be connected to ground through a capacitor C4 and also be coupled to the power terminal P5V. An enable pin EN of the converting chip U4 can be coupled to the power terminal P5V. Ground pins GND5-GND8 of the converting chip U4 can be connected to ground. An output pin OUT of the converting chip U4 can be coupled to the power terminal P3V3. An adjust pin ADJ of the converting chip U4 can be coupled to the power terminal P3V3 through a resistor R4, and also connected to ground through a resistor R5. The power terminal P3V3 can be connected to ground through a capacitor C5.

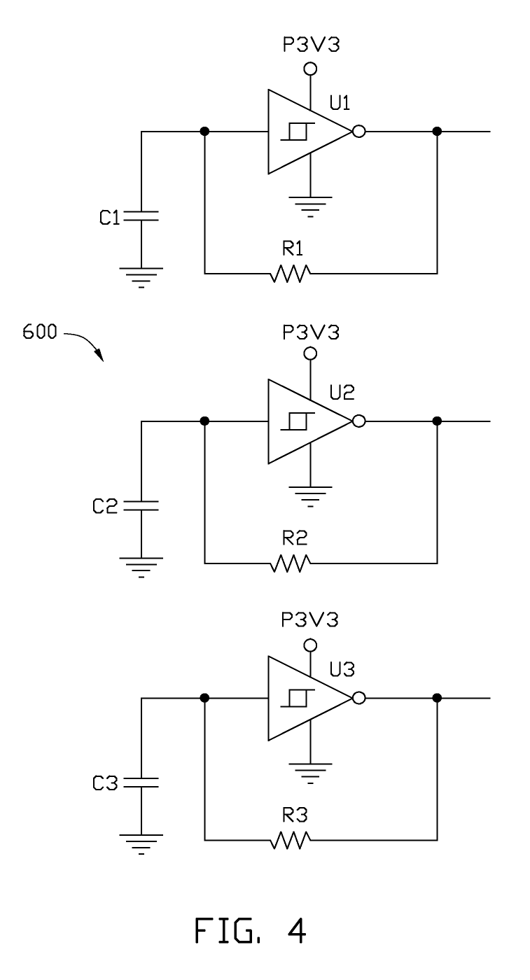

FIG. 4 illustrates a circuit diagram of the frequency generating circuit 600. The frequency generating circuit 600 can be coupled to the converting circuit 602 and the controller 60. The frequency converting circuit 600 can generate different frequencies to the controller 60. The frequency converting circuit 600 can comprise three regulators, U1-U3, three resistors, R1-R3, and three capacitors, C1-C3. A power terminal of each regulator can be coupled to the power terminal P3V3. A ground terminal of each regulator can be connected to ground. An input terminal of the regulator U1 can be connected to ground through the capacitor C1. An output terminal of the regulator U1 can be coupled to the input terminal of the regulator U1 through the resistor R1. The output terminal of the regulator U1 can output a first frequency. An input terminal of the regulator U2 can be connected to ground through the capacitor C2. An output terminal of the regulator U2 can be coupled to the input terminal of the regulator U2 through the resistor R2. The output terminal of the regulator U2 can be configured to output a second frequency. An input terminal of the regulator U3 can be connected to ground through the capacitor C3. An output terminal of the regulator U3 can be coupled to the input terminal of the regulator U3 through the resistor R3. The output terminal of the regulator U3 can output a first frequency.

In other embodiments, a type of server may need more than one server backplane 200 such as first and second backplanes. Hence, the first connector 10 of first backplane can be coupled to the fourth connector 40 of second backplane. In other embodiments, another type of server may need a third backplane. Hence, the second connector 20 can be coupled to the third connector 30 of the third backplane.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A server backplane configured to be coupled to one or more additional server backplane, the server backplane comprising:
a circuit board;
a first connector coupled to the circuit board and located at a first side of the circuit board;
a second connector coupled to the circuit board and located at a second side of the circuit board that is different from the first side of the circuit board;
a power connector arranged at a surface of the circuit board and coupled to the first connector and the second connector;
a plurality of hard disk drive interfaces operably coupled to respective HDDs;
a HDD controller interface coupled to the plurality of HDD interfaces and configured to be detachable from a motherboard and to communicate with the motherboard; and
a controller coupled to the plurality of HDD interfaces and the HDD controller interface, wherein the controller detects status of the HDD according to report signals from the HDD controller interface and status signals from the HDD interfaces.

2. The server backplane of claim 1, further comprising:
a converting circuit coupled to the power connector and configured to convert a first voltage from the power connector to a second voltage.

3. The server backplane of claim 2, further comprising:
a frequency generating circuit coupled to the controller and configured to generate various frequencies for the controller.

4. The server backplane of claim 3, wherein the frequency generating circuit comprises:
a plurality of regulators,
a power terminal of each regulator is coupled to the converting circuit,
a ground terminal of each regulator is connected to ground,
an input terminal of each regulator is connected to ground through a first capacitor, and
an output terminal of each regulator is coupled to the input terminal through a first resistor and is configured to output a frequency to the controller.

5. The server backplane of claim 4, wherein the converting circuit comprises:
a converting chip,
an input pin of the converting chip is coupled to the power connector, and is connected to a ground through a second capacitor,
an output pin of the converting chip is configured to output a converted voltage for the controller, and is connected to a ground through a third capacitor,
an adjust pin of the converting chip is connected to a ground through a second resistor, and is coupled to the power connector.

6. The server backplane of claim 5, further comprising:
first and second LEDs are configured to indicate the status of the HDD coupled to each HDD interface, when the HDD is coupled to the HDD interface normally, the controller outputs a first drive signal to control the first LED to be emitted light; when the HDD is coupled to the HDD interface malfunction, the controller outputs a second drive signal to control the second LED to be emitted light.

7. The server backplane of claim 6, wherein the HDD controller interface is a mini serial attached small computer system interface.

8. The backplane of claim 7, wherein the controller is a complex programmable logic controller chip.

9. The server backplane of claim 8 further comprising:
a third connector arranged at a third side of the circuit board; and
a fourth connector arranged at a fourth side of the circuit board;
wherein the power connector is coupled to the third and fourth connectors.

10. The server backplane of claim 9, wherein the first and second connectors are male connectors.

11. The server backplane of claim 9, wherein the third and fourth connectors are female connectors.
